(19) United States
(12) Patent Application Publication
(10) Pub. No.: US 2015/0193428 A1
(43) Pub. Date: Jul. 9, 2015

(54) SEMANTIC FRAME OPERATING METHOD BASED ON TEXT BIG-DATA AND ELECTRONIC DEVICE SUPPORTING THE SAME

(71) Applicant: Electronics and Telecommunications Research Institute, Daejeon (KR)

(72) Inventors: Soo Jong LIM, Daejeon (KR); Yeo Chan YOON, Daejeon (KR); Yoon Jae CHOI, Daejeon (KR); Chung Hee LEE, Daejeon (KR); Jeong HEO, Daejeon (KR); Hyo Jung OH, Daejeon (KR); Yo Han JO, Daejeon (KR); Mi Ran CHOI, Daejeon (KR); Myung Gil JANG, Daejeon (KR); Hyun Ki KIM, Daejeon (KR); Pum Mo RYU, Daejeon (KR)

(73) Assignee: Electronics and Telecommunications Research Institute, Daejeon (KR)

(21) Appl. No.: 14/256,414

(22) Filed: Apr. 18, 2014

(30) Foreign Application Priority Data
Jan. 8, 2014 (KR) 10-2014-0002177

(51) Int. Cl. G06F 17/27; G06F 17/28

(52) U.S. Cl. CPC G06F 17/2785; G06F 17/28

(57) ABSTRACT

Disclosed is semantic frame operation, and disclosed are a text big data based semantic frame operating method including: collecting a predicate to be used as a semantic frame seed; configuring a synonym set for the collected predicate; collecting one or more examples in text big data in association with predicates included in the synonym set; extracting a semantic frame candidate by attaching a semantic case to the collected examples; performing error verification for the semantic frame candidate; and storing the semantic frame candidate subjected to the error verification as an extended semantic frame for the predicate, and an electronic device supporting the same.

### CROSS-REFERENCE TO RELATED APPLICATIONS

This application claims priority to and the benefit of Korean Patent Application No. 10-2014-0002177 filed in the Korean Intellectual Property Office Jan. 8, 2014, the entire contents of which are incorporated herein by reference.

### TECHNICAL FIELD

The present invention relates to a semantic frame extension, and to a technology for automatically extending and constructing a semantic frame required for determining a meaning included in a natural language by using a lexicon-semantic network and collected text big data.

### BACKGROUND ART

As a method for constructing a semantic frame in the related, in the case of FrameNet (English), an example used based on a specific predicate is collected and a semantic frame is manually constructed based on the collected example. In the frame net scheme in the related art, since semantic cases which can be variously divided, such as an acting person case, an experienced person case, and a role case need to be applied differently from a syntactic frame based on a grammar based phrase case such as a subject, a predicate, an object, an adjunct, and a superlative noun phrase, a type in which a person directly performs a work has been applied by considering a difficulty or an importance of the work. However, since judgment of a characteristic, preliminary knowledge or the same data may be different for each person, a problem in consistency or a problem in time/cost has occurred.

In order to solve the problems, an automatic recognition technology using a learning data based machine learning technique may be an alternative, but performance is not realistically high, and as a result, there is a problem in that it is difficult that automatic construction also becomes a substantial alternative due to a property of a semantic frame which needs to be a base resource, that is, needs to have accuracy close to 100%. Moreover, in Korean, since a base resource such as FrameNet of English is not present, an automatic construction method primarily using a definite rule has been attempted. However, in the method in the related art, finding the definite rule is not also easy and coverage which can be constructed by the generated rule is small, and as a result, effectiveness deteriorates.

### SUMMARY OF THE INVENTION

The present invention has been made in an effort to provide a semantic frame operating method based on text big data that can construct a more accurate semantic frame by overcoming inefficiency and a decrease in manual input accuracy of automatic construction in the prior art in constructing the semantic frame, and a device supporting the same.

An exemplary embodiment of the present invention provides a text big data based semantic frame operating method including: collecting a predicate to be used as a semantic frame seed; configuring a synonym set for the collected predicate; collecting one or more examples in text big data in association with predicates included in the synonym set; extracting a semantic frame candidate by attaching a semantic case to the collected examples; performing error verification for the semantic frame candidate; and storing the semantic frame candidate subjected to the error verification as an extended semantic frame for the predicate.

The collecting of the seed may include at least one of collecting a predicate corresponding to an input signal input from an input unit as the semantic frame seed; and collecting information in which a synonym associated with a specific predicate is substituted with a different predicate as the semantic frame seed in an extended semantic frame which is worked in advance.

The configuring of the synonym set includes at least one of retrieving the synonym set in a lexical semantics network; outputting a synonym input window for inputting a synonym to a display unit and receiving an input of the synonym; and retrieving a synonym dictionary which is constructed in advance.

The collecting of the examples may include at least one of collecting examples of a predetermined quantity which is predefined in the text big data; collecting the examples in the text big data for a predetermined time which is predefined; and collecting the examples of the predetermined quantity which is predefined for a predetermined time.

The collecting of the examples may further include collecting information for an additional time or stopping information collection according to a predetermined set-up when the examples of the predetermined quality which is predefined are not collected for the corresponding time.

The method may further include, after the collecting of the examples, filtering examples having the same meaning as the predicate by performing lexical semantic analysis for the collected examples.

The filtering may include judging whether the predicate has the same meaning in accordance with at least one type of a subject, an object, and an adjunct associated with the predicate.

The verifying may include verifying whether to generate a semantic frame by substituting a semantic level synonym by using a synonym set collected based on a predicate corresponding to the semantic frame seed, and performing verification of checking frequency information for a semantic frame candidate in which a synonym is substitutable and a semantic case and a semantic category match.

The method may further include selecting another predicate in the synonym set for the predicate to provide the selected predicate as semantic frame seed recommendation information.

The providing of the predicate as the semantic frame seed recommendation information may include extracting the semantic frame seed recommendation information from semantic frames in which the number of sentences acquired through the example extraction and the semantic level filtering is equal to or more than a predetermined number which is predefined.

Another exemplary embodiment of the present invention provides a text big data based semantic frame operating electronic device, including: a communication unit configured to form a communication channel associated with collection of text big data; a control unit configured to collect one or more examples in the text big data in association with a synonym set configured based on a predicate of an input semantic frame seed, extract a semantic frame candidate by attaching a semantic case to the collected examples, and extract an extended semantic frame by performing error verification associated with the same semantics for the semantic frame candidate; and a storage unit configured to store the extended semantic frame.

The electronic device may further include an input unit configured to support at least one of the input of the semantic frame seed and the input of the synonym set.

The electronic device may further include a display unit configured to output semantic frame seed recommendation information in which a synonym associated with a specific predicate is substituted with a different predicate in an extended semantic frame which is worked in advance.

The control unit may extract the semantic frame seed recommendation information from semantic frames in which the number of sentences acquired through the example extraction and the semantic level filtering is equal to or more than a predetermined number which is predefined.

The control unit may control the synonym set to be retrieved or a preconstructed synonym dictionary to be retrieved by using a lexical semantics network.

The control unit may collect the examples in the text big data in accordance with at least one criterion of a predetermined quantity which is predefined or a predetermined time which is predefined, and a predetermined quantity which is predefined for a predetermined time.

The control unit may collect information for an additional time or information collection according to a predetermined set-up to be collected or stopped to be collected when the examples of the predetermined quality which is predefined are not collected for the corresponding time.

The control unit may filter examples having the same meaning as the predicate by performing lexical semantic analysis for the collected examples.

The control unit may judge whether the predicate has the same meaning in accordance with at least one type of subject, object, and adjunct associated with the predicate.

The control unit may verify whether to generate a semantic frame by substituting a semantic level synonym by using a synonym set collected based on a predicate corresponding to the semantic frame seed, and performs verification of checking frequency information for a semantic frame candidate in which a synonym is substitutable and a semantic case and a semantic category match.

As described above, according to the semantic frame operating method based on text big data and a device supporting the same, user interference is suppressed and verification based on the text big data and a lexical semantic network is used in extending the semantic frame, thereby constructing the semantic frame with higher reliability.

In the present invention, it is possible to resolve problems such as a lot of time required and high cost in constructing and verifying the semantic frame can be resolved, which occur by dependence on a user's manual work in the prior art.

In the present invention, a semantics based knowledge service that intends to analyze an insight in the text big data is activated, and as a result, overall utilization of the text big data can be increased.

### BRIEF DESCRIPTION OF THE DRAWINGS

FIG. 1 illustrates a configuration of an electronic device supporting a semantic frame operation according to an exemplary embodiment of the present invention.

FIG. 2 is a diagram more specifically illustrating a configuration of a control unit according to an exemplary embodiment of the present invention.

FIG. 3 is a diagram more specifically illustrating a configuration of a semantic frame verification unit of the present invention.

FIG. 4 is a diagram for describing an example of an answer search by simple sentence matching with a question.

FIG. 5 is a diagram for describing an example of the answer search by application of a syntactic analysis technology to the question.

FIG. 6 is a diagram for describing an example of the answer search by semantic analysis according to an exemplary embodiment of the present invention.

FIG. 7 is a diagram for describing a semantic frame operating method according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, various exemplary embodiments of the present invention will be described in detail with reference to the accompanying drawings. In this case, it is noted that like reference numerals refer to like elements in the accompanying drawings. Further, a detailed description of a known function and a know constitution which may obscure the spirit of the present invention will be skipped. That is, it should be noted that in the following description, only a part required to understand an operation according to the exemplary embodiment of the present invention will be described and a description of other parts will be skipped to obscure the spirit of the present invention.

According to the present invention described below, when a lot of texts are automatically analyzed and the analyzed texts are constructed by a semantic frame, a room that inaccurate semantic frame data which may be caused due to an automatic construction work may be included may be minimized through a verification process considering a lexical semantics network and frequency information.

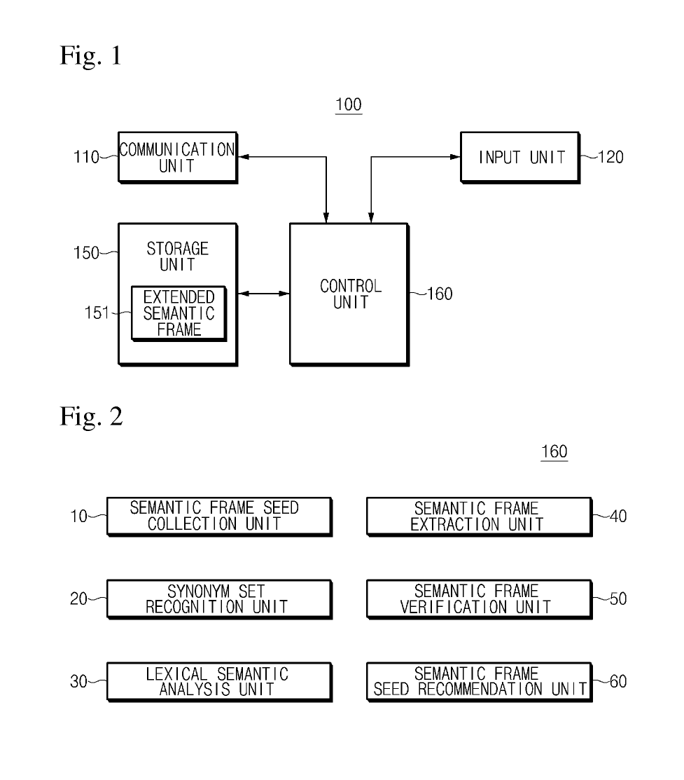

FIG. 1 illustrates a configuration of an electronic device supporting a semantic frame operation according to an exemplary embodiment of the present invention.

Referring to FIG. 1, a semantic frame operating electronic device 100 according to the exemplary embodiment of the present invention may include a communication unit 110, an input unit 120, a storage unit 150, and a control unit 160.

The semantic frame operating electronic device 100 having such a configuration may extend and construct a semantic frame seed input through the input unit 120 by using big data collected through the communication unit 110. In the meantime, the semantic frame operating electronic device 100 verifies a semantic frame which is extended and constructed through automatic comparison of semantic cases to increase the reliability of the extended and constructed semantic frame.

The communication unit 110 may be configured to perform a communication function of the semantic frame operating electronic device 100. The communication unit 110 may form a communication channel for receiving text big data. For example, the communication unit 110 may transmit data regarding a specific search word or a specific predicate to other server device or electronic device according to a control by the control unit 160 and receive information associated with the transmitted data from the other server device or electronic device. In this case, the data may be collected in a text format. The text big data collected by the communication unit 110 is provided to the control unit 160 to be used for extending the semantic frame. Meanwhile, when the semantic frame operating electronic device 100 of the present invention is used as a question answering device, the communication unit 110 may form a channel for receiving a question and transmitting an answer to the question.

The input unit 120 may generate an input signal associated with inputting the semantic frame seed. The semantic frame seed may be input by a user. To this end, the input unit 120 may include one or more key buttons for inputting the semantic frame seed. For example, the input unit 120 may be a keyboard. When the semantic frame operating electronic device 100 includes a touch screen type display unit, the input unit 120 may include a touch screen and output a map in which characteristics or number keys for inputting the semantic frame through the touch screen are arranged. Alternatively, the semantic frame seed may be data which corresponds to a predicate included in a specific electronic dictionary or specific materials. To this end, the input unit 120 may include an input interface to receive the electronic dictionary or the electronic material. The input interface may include various communication interfaces including an audio processing module that supports audio signal collection and voice recognition functions, a USB interface or a UART interface that may receive the data corresponding to the electronic dictionary or the electronic material, and the like. The aforementioned input unit 120 is not limited to a specific shape or form, but may be appreciated as an input means capable of inputting the semantic frame seed. The aforementioned input unit 120 may generate an input signal associated with the inputting of the semantic frame seed and transfer the generated input signal to the control unit 160. Meanwhile, when the semantic frame operating electronic device 100 operates as the question answering device, the input unit 120 may be used as a configuration for user input, for example, question input.

The storage unit 150 may temporarily store the text big data collected through the communication unit 110. After semantic frame extension for a specific semantic frame seed, the text big data stored in the storage unit 150 may be removed or stored and managed. The storage unit 150 may also store information on semantic frame seeds. The storage unit 150 may store various routines associated with semantic frame extraction and rules associated with semantic frame verification. The routines associated with the semantic frame extraction and the rules associated with the semantic frame verification are loaded to the control unit 160 to be used in extending and constructing the semantic frame.

Meanwhile, the storage unit 150 may store an extended semantic frame 151 which is extended and constructed based on the text big data. The extended semantic frame 151 may be used as a database. When the semantic frame operating electronic device 100 is used as the question answering device, the extended semantic frame 151 stored in the storage unit 150 may be searched as an answer result to a received question. The searched specific extended semantic frame 151 and various examples associated with the extended semantic frame may be provided to a user device that transmits the question or output through an output device provided in the semantic frame operating electronic device 100, for example, a display unit.

The control unit 160 may control processing and transferring of a control signal and collecting, transferring, and processing of data in association with general control of the semantic frame operating electronic device 100. In particular, the control unit 160 of the present invention may extend and construct the semantic frame based on the input semantic frame seed and the collected text big data. The control unit 160 may support a question answering service based on the extended semantic frame 151 stored in the storage unit 150. To this end, the control unit 160 may include the configuration illustrated in FIG. 2.

FIG. 2 is a diagram more specifically illustrating a configuration of a control unit according to an exemplary embodiment of the present invention.

Referring to FIG. 2, the control unit 160 of the present invention may include a semantic frame seed collection unit 10, a synonym set recognition unit 20, a lexical semantic analysis unit 30, a semantic frame extraction unit 40, a semantic frame verification unit 50, and a semantic frame seed recommendation unit 60. Meanwhile, the semantic frame operating electronic device 100 may include text big data collected on a large scale in a lexical semantics network and a web constructed in advance for extending the semantic frame. The text big data may be stored in the storage unit 150 as described above. The lexical semantics network also may be stored in the storage unit 150 and thereafter, provided by a request from the control unit 160. Alternatively, in the lexical semantics network, a separate server device may be provided, and the control unit 160 may form a communication channel with a server device that provides a corresponding configuration in order to use the lexical semantics network.

The semantic frame seed collection unit 10 is configured to collect the semantic frame seed. The semantic frame seed collection unit 10 may provide a screen for collecting the semantic frame seed through the display unit. For example, the semantic frame seed collection unit 10 may output an input window for collecting the semantic frame seed when performing the semantic frame extension function of the present invention. The semantic frame seed collection unit 10 may collect the semantic frame seed which a user inputs by using the input unit 120. For example, when a semantic frame seed corresponding to ‘ [symbol] ’ in a Korean standard unabridged dictionary is input through the input unit 120, the semantic frame seed collection unit 10 may define the semantic frame. For example, in the Korean standard unabridged dictionary, ‘die’ may have both semantics may mean that life disappears or is cut and that a predetermined part of an object cannot be upright or sharp but is depressed or becomes blunt. The semantic frame seed collection unit 10 may define a meaning selected by default among various dictionary semantics or a meaning indicated by the input unit 120 as the semantic frame seed. For example, as the semantic frame seed, ‘<people>!(experienced person case) die’ may be input. Herein, the people may fall within a semantic category and the experienced person case may be a semantic case.

The synonym set recognition unit 20 may collect a synonym having the same meaning as the corresponding semantic frame seed by referring to the semantic frame defined by the semantic frame seed collection unit 10. For example, the synonym set recognition unit 20 may be configured to recognize a synonym set having the same meaning as ‘die’. The synonym set recognition unit 20 may configure information on the synonym set by using the synonym input by the input unit 120 as in the semantic frame seed collection unit 10. To this end, the user may input the synonym having the same meaning as the semantic frame seed by using the input unit 120. Alternatively, the synonym set recognition unit 20 provides the predicate input as the semantic frame seed to a synonym set (synset) function of the lexical semantics network and receives the synonym set provided by the lexical semantics network to automatically configure the received synonym set. The synonym set recognition unit 20 accesses a server device that provides the prestored synonym dictionary or synonym dictionary information to provide the predicate input as the semantic frame seed and receives a synonym corresponding to the predicate. The synonym set recognition unit 20 may configure the synonym set by using the lexical semantics network for the semantic frame seed based on an exemplary embodiment of the aforementioned ‘die’. For example, the synonym set recognition unit 20 may collect ‘ [symbol] ’, ‘ [symbol] ’, ‘ [symbol] ’, ‘ [symbol] ’, ‘ [symbol] ’, ‘ [symbol] ’, and the like as the synonym set for ‘die’. Herein, ‘ [symbol] ’ may have a meaning that ‘people die’. ‘ [symbol] ’ may have a meaning that a person loses life while finishing duty. ‘ [symbol] ’ may have a meaning that people die as honorific expression.

The lexical semantic analysis unit 30 extracts an example of a lexicon used in the synonym set from the text big data. The lexical semantic analysis unit 30 may perform filtering by using a lexical semantic analysis technology predefined for the extracted example. For example, the lexical semantic analysis unit 30 may perform filtering of an example used for a different meaning in spite of the same lexicon as represented in Table 1 below.

TABLE 1

| Examples | Filtering target |
|---|---|
| A lot of solders died in the war | X |
| Since a sword was used long, the | 0 (filtering) |
| blade of the sword becomes blunt | |
| A son deceased in the war | X |
| The man passed away in prison at | X |
| the age of 51 | |

The lexical semantic analysis unit 30 may collect example sentences having a semantic level associated with the synonym set represented in Table 1 as many as possible in the text big data. For example, the lexical semantic analysis unit 30 may collect example sentences of a predetermined quantity which is defined in advance or more in the text big data or for a predetermined time which is defined in advance.

The semantic frame extraction unit 40 automatically extracts the semantic frame by targeting the example collected by the lexical semantic analysis unit 30. To this end, the semantic frame extraction unit 40 may use a semantic case attachment technology. For example, the semantic frame extraction unit 40 may extract a semantic frame in which a semantic case attachment is provided as represented in Table 2 below.

TABLE 2

| | |
|---|---|
| Example 1 | In <combat>!(location case) |
| | <person>!(experienced person case) died |
| Example 2 | <person>!(experienced person case) in |
| | <combat>!(location case) died |
| Example 3 | <person>!(acting person case) at <time>! in |
| | <location>! died |

The semantic frame extraction unit 40 may extract semantic frame candidates of a predetermined quantity or more as represented in Table 2 by using the text big data. The extracted semantic frame candidates may be finally constructed as the extended semantic frame 151 through the semantic frame verification unit 50. In Table 2, ‘acting person case’ of a semantic frame presented in example 3 shows a room for error during an automatic extraction process. Actually, it may be correct that as ‘action qualification’, the experienced person case is extracted. The error which occurs in example 3 may be verified by the semantic frame verification unit 50 to be filtered.

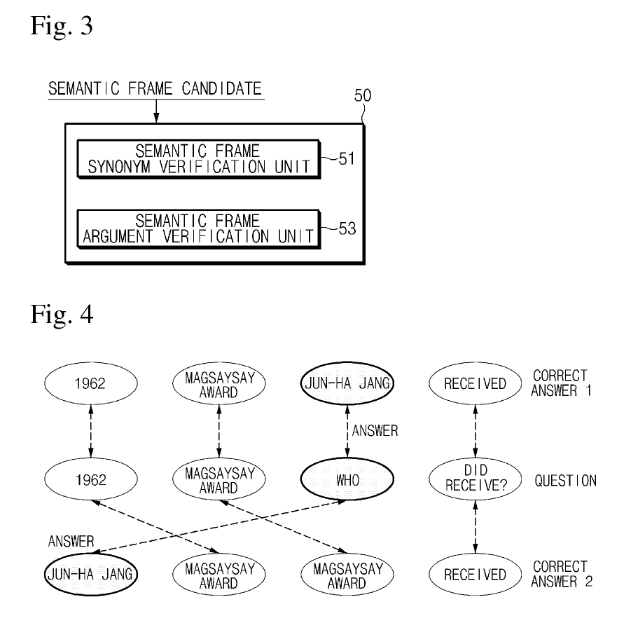

The semantic frame verification unit 50 may be configured to detect a semantic frame candidate in which an error occurs among the semantic frame candidates extracted by the semantic frame extraction unit 40. To this end, the semantic frame verification unit 50 may include a semantic frame synonym verification unit 51 and a semantic frame argument verification unit 53 as illustrated in FIG. 3. The semantic frame candidates extracted by the semantic frame extraction unit 40 may be provided to the semantic frame synonym verification unit 51.

FIG. 3 is a diagram more specifically illustrating a configuration of a semantic frame verification unit of the present invention.

The semantic frame synonym verification unit 51 substitutes the synonym in terms of the semantic level by using the synonym set recognized by the synonym set recognition unit 20 based on the predicate input in the semantic frame seed to verify whether to generate the semantic frame. The semantic frame synonym verification unit 51 examines whether a first semantic case of the semantic frame candidates matches, whether a semantic category of a second argument matches, or the like. The semantic frame synonym verification unit 51 may finally apply frequency information to the semantic frame candidate in which the synonym is substitutable and the semantic case and the semantic category match. That is, the semantic frame synonym verification unit 51 may judge that the corresponding synonym may be finally applied to the extended semantic frame when the corresponding synonym shows a frequency which is equal to or more than a predetermined threshold. The semantic frame added in this step may be represented in Table 3 below.

TABLE 3

| | |
|---|---|
| Semantic frame candidate | <person>!(experienced person case) in |
| | <combat>! died. |
| Synonym verification | <person>!(experienced person case) died. |
| semantic frame | |

The semantic frame argument verification unit 53 performs argument verification for the semantic frame candidates. The semantic frame argument verification unit 53 may use semantic frames verified as the synonym even though the semantic frame seed is different. In the meantime, a frequency of the semantic frame may be calculated by the synonym set unit. The semantic frame argument verification unit 53 may calculate the frequency on the assumption that that the semantic frame is the same in information represented in Table 4.

TABLE 4
In <combat>!(location case) <person>!(experienced person case) died
<person>!(experienced person case) in <combat>!(location case) died

That is, the semantic frame argument verification unit 53 may verify the semantic frame on the assumption that the predicate which belongs to the same synonym set is the same when the semantic category and the semantic case of the argument are the same. The semantic frame candidate that undergoes the aforementioned semantic frame synonym verification and semantic frame argument verification is stored as the extended semantic frame 151.

The semantic frame seed recommendation unit 60 is configured to recommend the semantic frame seed for extending to a meaning of other predicates. The semantic frame seed recommendation unit 60 is provided to refer to the semantic frame seed collected by the semantic frame seed collection unit 10. To this end, the semantic frame seed recommendation unit 60 changes a predicate part to a different synonym set in the extended semantic frame 151 in which the semantic frame verification is completed to recommend the corresponding predicate. In this case, the semantic frame seed recommendation unit 60 may target and recommend semantic frames in which the number of sentences acquired through example extraction and semantic level filtering is equal to or more than a predetermined number which is defined in advance. Herein, the predetermined number may be changed or fixed according to an intention of a system designer. The semantic frame recommended by the semantic frame seed recommendation unit 60 may be output through the display unit of the semantic frame operating electronic device 100 so as to be selected by the user, and selected information may be selected as a new semantic frame seed by user selection and the extended semantic frame may be constructed by operating the aforementioned components. Meanwhile, the semantic frame operating electronic device 100 may automatically construct the extended semantic frame for the recommended semantic frame seed according to predefined schedule information when there is no separate user selection. The extended semantic frame construction may be repeated as many as substitutable predicates in another synonym set or performed according to a predetermined substitution number which is defined in advance.

The semantic frame operating electronic device 100 may support a natural word processing application function through semantic level analysis. For example, the semantic frame operating electronic device 100 may provide a function to search a correct answer in a question answering system.

FIG. 4 is a diagram for describing an example of a response search by simple sentence matching with a question.

Referring to FIG. 4, for a question ‘Who received Magsaysay award in 1962?’, will be considered as a correct answer candidate group including ‘In 1962, Jun-ha Jang received Magsaysay award.’ as described in correct answer candidate sentence 1, ‘Jun-ha Jang received, in 1962, Magsaysay award.’ as described in correct answer candidate sentence 2, and ‘In 1962, Magsaysay award a press prize is presented to Jun-ha Jang.’ as described in correct answer candidate sentence 3. Herein, when simple sentence matching is used, a correct answer that a person who received Magsaysay award in the correct answer candidate sentence 1 is ‘Junha Jang’ may be extracted, but when a word order is changed as illustrated in the correct answer candidate sentence 2, the correct answer may not be found through the simple sentence matching.

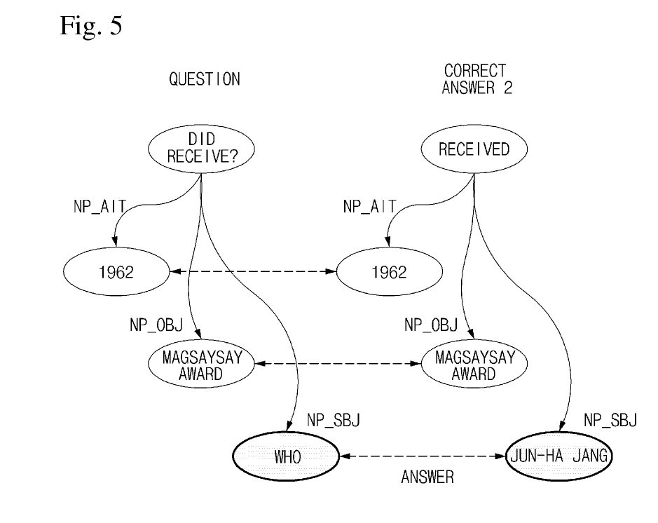

FIG. 5 is a diagram for describing an example of the response search by application of a syntactic analysis technology to the question.

Referring to FIG. 5, when a syntax analysis technology is used, since a subject, an object, an adjunct, and the like match regardless of the word order based on the predicate ‘receive’, a correct answer associated with “Jun-ha Jang” in the correct answer candidate sentence 1 and the correct answer candidate sentence 2 may be extracted with respect to the question mentioned in FIG. 4 although the word order is changed. However, if the semantic level analysis is not performed like a case of the correct answer candidate sentence 3 even when syntax information is used, the correct answer may not be found.

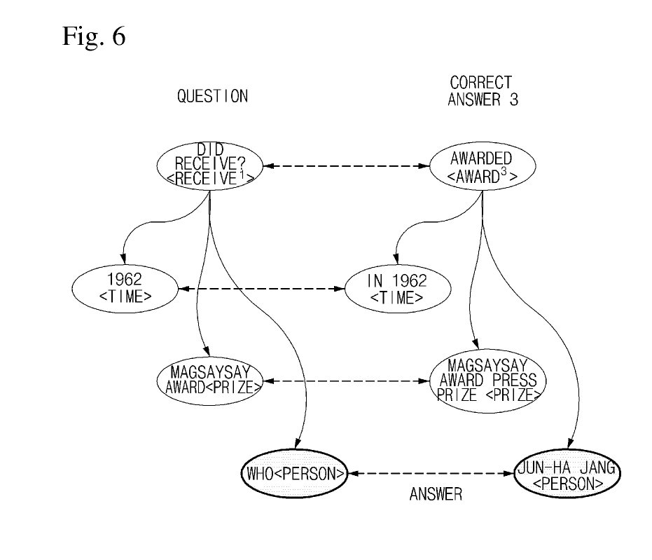

FIG. 6 is a diagram for describing an example of the response search by semantic analysis according to an exemplary embodiment of the present invention.

As illustrated in FIG. 6, when a semantic frame based semantic analysis technology is used with respect to the correct answer candidate sentence 3 in which the correct answer is not found by syntax analysis level information, the correct answer may be found. First, the control unit 160 of the semantic frame operating electronic device 100 of the present invention performs text big data and lexical semantic analysis and a verification process of the semantic frame candidate group to determine that an accurate meaning (herein, a first meaning of ‘receive’ written in the dictionary) of ‘receive’ used in the question and a meaning ‘award’ (herein, a third meaning of ‘receive the award’ written in the dictionary) are the same as each other. The control unit 160 performs semantic frame based matching with the question to perform semantic matching even though an expression of ‘Magsaysay award’ in a question sentence and an expression of ‘Magsaysay award press prize’ in the correct answer candidate sentence 3 are different from each other. That is, the control unit 160 may recognize both expressions as sentences having the same meaning. As described above, the semantic frame operating electronic device 100 of the present invention supports finding the correct answer which may not be found by syntax analysis level analysis by applying semantic analysis for a specific answer.

As described above, according to the present invention, when a specific semantic frame which becomes a seed is input, the extended semantic frame is constructed based on the input semantic frame and the extended and constructed semantic frame is automatically verified. In the meantime, according to the present invention, the lexical semantics network, a lexical semantic analysis module capable of granting semantics to the lexicon, and large-scale text big data may be used.

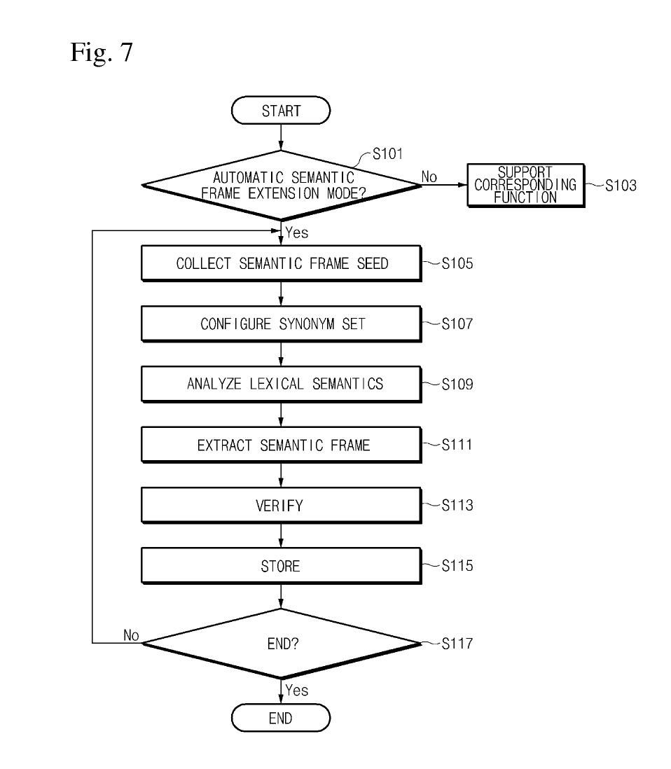

FIG. 7 is a diagram for describing a semantic frame operating method according to an exemplary embodiment of the present invention.

Referring to FIG. 7, the control unit 160 of the semantic frame operating electronic device 100 may check an automatic semantic frame extension mode state or not in step S101. Alternatively, the control unit 160 may check whether an input event to request automatic semantic frame extension or a predefined schedule event arrives. In step S101, when an automatic semantic frame extension mode is in an inactivated state or a corresponding event does not occur, the control unit 160 branches to step S103 to support performing a specific function or a predefined function of the semantic frame operating electronic device 100 depending on a type of an event which occurs. Alternatively, the control unit 160 may control a previous state, for example, a stand-by state to be maintained.

In step S101, when the automatic semantic frame extension mode is in an activated state or an automatic semantic frame extension associated event occurs, the control unit 160 may support collecting the semantic frame seed in step S105. In this step, the control unit 160 may control the input unit 120 associated with the input of the semantic frame seed to be activated. Alternatively, the control unit 160 may receive the semantic frame seed through the communication unit 110 or be input with the semantic frame seed through an input interface. The control unit 160 may output a semantic frame seed input window for inputting the semantic frame seed. In the meantime, the control unit 160 may provide semantic frame seed recommendation information. The semantic frame seed recommendation information may include information in which a synonym of a specific predicate is substituted with other predicate in an extended semantic frame which is worked in advance.

Next, the control unit 160 may configure the synonym set in step S107. To this end, the control unit 160 may extract the predicate from the semantic frame seed and search a synonym for the extracted predicate. The control unit 160 may search the synonym set in the lexical semantics network for searching the synonym. Alternatively, the control unit 160 may output a synonym input window to the display unit for inputting the synonym and collect the synonym depending on an input signal input from the input unit 120 for inputting the synonym. Alternatively, the control unit 160 may configure the synonym set by searching a synonym dictionary which is constructed in advance. The synonym dictionary may be provided from other external server device or electronic device. In this case, the control unit 160 may form the communication channel with the other external server device or electronic device that provides the synonym dictionary. The synonym dictionary may also be stored in the storage unit 150. In this case, the control unit 160 may search the synonym having the same meaning as the predicate provided from the semantic frame seed in the synonym dictionary stored in the storage unit 150.

Next, the control unit 160 may perform the lexical semantic analysis in step S109. During the lexical analysis, the control unit 160 may collect various examples included in the text big data. In this case, the control unit 160 may collect examples of a predetermined quantity or more which is defined in advance or collect the examples for a predetermined time which is defined in advance. The control unit 160 may control the example collection to be stopped when the examples of the predetermined quantity which is predefined are collected while collecting the examples within the predetermined time. Alternatively, the control unit 160 may collect information for an additional time or stop collecting information according to a predetermined set-up when the examples of the predetermined quantity which is predefined are not collected for the corresponding time. In the meantime, the control unit 160 may perform filtering of the predicate used as different semantics by using the predefined lexical analysis technology. For example, the control unit 160 may filter the predicate used as different semantics according to a type of the subject. According to an exemplary embodiment, the control unit 160 may judge the predicate ‘die’ as the predicate used to have different semantics by dividing a case in which the subject is a person and a case in which the subject is a thing or a characteristic. According to another exemplary embodiment, the control unit 160 may differently perform predicate filtering according to subject checking and checking the presence of the object with respect to the predicate ‘award’ based on the predefined lexical analysis technology. That is, the control unit 160 may judge ‘award’ in a sentence of ‘a person awards’ and ‘award’ in a sentence of ‘a person awards a prize’ as different examples and filter any one according to a predicate search criterion.

The control unit 160 may extract the semantic frame candidate in step S111 when the examples are collected. The control unit 160 may extract a semantic frame in which semantic cases are defined by using a semantic case attachment function while extracting the semantic frame candidate.

Next, the control unit 160 may perform error verification for the extracted semantic frame candidates in step S113. The control unit 160 may verify whether to generate the semantic frame by substituting the semantic level synonym by using the synonym set collected based on the predicate input in the semantic frame seed while verifying the semantic frame. For example, the control unit 160 may examine whether a first semantic case of the semantic frame candidates matches, whether a semantic category of a second argument matches, or the like. The control unit 160 may check frequency information for the semantic frame candidate in which the synonym may be substituted and the semantic case and the semantic category match. That is, the control unit 160 may judge that the synonym that shows a frequency which is equal to or more than a threshold may be applied to the extended semantic frame. Meanwhile, the control unit 160 may perform argument verification for the semantic frame candidates. The control unit 160 may use semantic frames verified as the synonym even though the semantic frame seed is different. The control unit 160 may judge that the predicates which belong to the same synonym set have the same semantic frame when the semantic category and the semantic case of the argument are the same.

The control unit 160 may store the semantic frame candidate that undergoes the aforementioned semantic frame synonym verification and semantic frame argument verification in step S113 as the extended semantic frame 151 in step S115. Herein, the control unit 160 may recommend the semantic frame seed by using the extended semantic frame 151 stored in step S115 and the synonym set for the semantic frame seed. The control unit 160 may change a predicate part to a different synonym set in the extended semantic frame 151 in which the semantic frame verification is completed and recommend the predicate. In this case, the control unit 160 may extract and provide semantic frame seed recommendation information from semantic frames in which the number of sentences acquired through example extraction and semantic level filtering is equal to or more than a predetermined number which is defined in advance. In the meantime, the control unit 160 may output the semantic frame seed recommendation information to the display unit.

Next, the control unit 160 may verify whether an event associated with a function end occurs in step S117. The control unit 160 may reperform the following process by branching to the previous step of step S105 when the function end event does not occur. While reperforming the following process, the control unit 160 may automatically construct the extended semantic frame 151 based on the semantic frame seed recommendation information. That is, when the semantic frame seed recommendation information is provided, the control unit 160 may select specific information among the provided recommendation information by default or automatically construct the extended semantic frame for a predicate selected by the user.

The semantic frame operating method and electronic device 100 of the present invention may support technologies including a question answering system, a machine translation system, information extraction, a text mining technology, semantic based information retrieval, and the like through understanding the semantic level text based on the semantic frame. In particular, when the question answering system is described as an example, a question answering service may be first classified into mobile question answering, web based question answering, and question answering for specialized domains such as a law or an education. In the question answering service, since the extension and construction of the semantic frame suitable for a domain and a context need to precede, the present invention may support a service through not word matching level analysis but semantic level analysis. The device and the method of the present invention may define a user's question of a natural word as the predicate in the question answering service and recognize the defined predicate at the semantic level by using the semantic frame based on the defined predicate, and as a result, even in a sentence which becomes the candidate of the correct answer, the predicate is recognized at the semantic level to extract a correct answer desired by the user through the semantic level matching.

The semantic frame operated through such a process may be used as a semantic level extraction of knowledge (knowledge extraction) technology, a correct answer recognition of the question answering system in the extracted knowledge (answering recognition) technology, and a correct answer generation using the recognized correct answer (answer generation) technology. As described above, in the present invention, semantic analysis level information using the semantic frame may enable a question answering service improved as compared with a context information level service in the question answering system.

The exemplary embodiments of the present invention are illustrative only, and various modifications, changes, substitutions, and additions may be made without departing from the technical spirit and range of the appended claims by those skilled in the art, and it will be appreciated that the modifications and changes are included in the appended claims.

What is claimed is:

1. A text big data based semantic frame operating method, comprising:
collecting a predicate to be used as a semantic frame seed;
configuring a synonym set for the collected predicate;
collecting one or more examples in text big data in association with predicates included in the synonym set;
extracting a semantic frame candidate by attaching a semantic case to the collected examples;
performing error verification for the semantic frame candidate; and
storing the semantic frame candidate subjected to the error verification as an extended semantic frame for the predicate.

2. The method of claim 1, wherein the collecting of the seed includes at least one of:
collecting a predicate corresponding to an input signal input from an input unit as the semantic frame seed; and
collecting information in which a synonym associated with a specific predicate is substituted with a different predicate as the semantic frame seed in an extended semantic frame which is worked in advance.

3. The method of claim 1, wherein the configuring of the synonym set includes at least one of:
retrieving the synonym set in a lexical semantics network;
outputting a synonym input window for inputting a synonym to a display unit and receiving an input of the synonym; and
retrieving a synonym dictionary which is constructed in advance.

4. The method of claim 1, wherein the collecting of the examples includes at least one of:
collecting examples of a predetermined quantity which is predefined in the text big data;
collecting the examples in the text big data for a predetermined time which is predefined; and
collecting the examples of the predetermined quantity which is predefined for a predetermined time.

5. The method of claim 4, wherein the collecting of the examples further includes collecting information for an additional time or stopping information collection according to a predetermined set-up when the examples of the predetermined quality which is predefined are not collected for the corresponding time.

6. The method of claim 1, further comprising:
after the collecting of the examples, filtering examples having the same meaning as the predicate by performing lexical semantic analysis for the collected examples.

7. The method of claim 6, wherein the filtering includes judging whether the predicate has the same meaning in accordance with at least one type of subject, object, and adjunct associated with the predicate.

8. The method of claim 1, wherein the verifying includes:
verifying whether to generate a semantic frame by substituting a semantic level synonym by using the synonym set collected based on the predicate associated with the semantic frame seed; and
checking frequency information for a semantic frame candidate in which the synonym is substitutable and a semantic case and a semantic category match.

9. The method of claim 1, further comprising:
selecting another predicate in the synonym set for the predicate to provide the selected predicate as semantic frame seed recommendation information.

10. The method of claim 9, wherein the providing of the predicate as the semantic frame seed recommendation information includes extracting the semantic frame seed recommendation information from semantic frames in which the number of sentences acquired through the example extraction and the semantic level filtering is equal to or more than a predetermined number which is predefined.

11. A text big data based semantic frame operating electronic device, comprising:
a communication unit configured to form a communication channel associated with collection of text big data;
a control unit configured to collect one or more examples in the text big data in association with a synonym set configured based on a predicate of an input semantic frame seed, extract a semantic frame candidate by attaching a semantic case to the collected examples, and extract an extended semantic frame by performing error verification associated with the same semantics for the semantic frame candidate; and
a storage unit configured to store the extended semantic frame.

12. The device of claim 11, further comprising:
an input unit configured to support at least one of the input of the semantic frame seed and the input of the synonym set.

13. The device of claim 11, further comprising:
a display unit configured to output semantic frame seed recommendation information in which a synonym associated with a specific predicate is substituted with a different predicate in an extended semantic frame which is worked in advance.

14. The device of claim 13, wherein the control unit extracts the semantic frame seed recommendation information from semantic frames in which the number of sentences acquired through the example extraction and the semantic level filtering is equal to or more than a predetermined number which is predefined.

15. The device of claim 11, wherein the control unit controls the synonym set to be retrieved or a preconstructed synonym dictionary to be retrieved by using a lexical semantics network.

16. The device of claim 11, wherein the control unit collects the examples in the text big data in accordance with at least one criterion of a predetermined quantity which is predefined or a predetermined time which is predefined, and a predetermined quantity which is predefined for a predetermined time.

17. The device of claim 16, wherein the control unit controls information for an additional time or information collection according to a predetermined set-up to be collected or stopped to be collected when the examples of the predetermined quality which is predefined are not collected for the corresponding time.

18. The device of claim 11, wherein the control unit filters examples having the same meaning as the predicate by performing lexical semantic analysis for the collected examples.

19. The device of claim 18, wherein the control unit judges whether the predicate has the same meaning in accordance with at least one type of subject, object, and adjunct associated with the predicate.

20. The device of claim 11, wherein the control unit verifies whether to generate a semantic frame by substituting a semantic level synonym by using a synonym set collected based on a predicate corresponding to the semantic frame seed, and performs verification of checking frequency information for a semantic frame candidate in which a synonym is substitutable and a semantic case and a semantic category match.
